(19) United States
(12) Patent Application Publication
(10) Pub. No.: US 2014/0101673 A1
(43) Pub. Date: Apr. 10, 2014

(54) DYNAMIC DEPENDENCY EVALUATION FOR COMPUTING TASK EXECUTION

(71) Applicant: MICROSOFT CORPORATION, Redmond, WA (US)

(72) Inventors: Andriy Klyuchevskyy, Redmond, WA (US); Richard P. Lewis, Lynwood, WA (US)

(73) Assignee: MICROSOFT CORPORATION, Redmond, WA (US)

(21) Appl. No.: 13/645,682

(22) Filed: Oct. 5, 2012

(51) Int. Cl. G06F 9/46

(52) U.S. Cl. 718/106

(57) ABSTRACT

The subject disclosure is directed towards scheduling computing task execution by dynamically evaluating dependencies between computing tasks. After executing independent computing tasks in parallel, one or more dependent tasks are scheduled for execution. Unless a task failed, dependencies between remaining tasks are examined to identify one or more computing tasks that do not correspond to a dependency and/or one or more computing tasks that depend upon successfully completed tasks. Dynamic dependency evaluation may be applied to improve self-healing task execution.

### BACKGROUND

Computing device operating systems manage execution of various computing tasks supporting user applications and processing user data. A computing task generally refers to a basic unit of asynchronous and/or synchronous programming. The operating system may define computing tasks as at least part of a program and/or each successive invocation of the program. Computing tasks are often related to each other and relationships (e.g., dependencies) between these tasks often influence task results. There are number of relationships types, including but not limited to, the following types: finish-to-start, start-to-start, finish-to-finish, and start-to-finish. In addition, relationships between two or more computing tasks often change as some of these tasks are completed. Once a task executes successfully, any dependent task, therefore, no longer depends on that task. There are other reasons dependencies change.

One example computing task may be a self-healing task, which generally involves configuring an operating system and any related components. Self-healing tasks may be performed for the purpose of providing a suitable operating system environment to one or more computing devices and/or for multiple users. Each self-healing task may consume substantial resources in terms of time, throughput and capacity. Such consumption often results from setting up different independent and dependent operating system components/settings. One conventional approach to execute self-healing tasks configuring components in a serial or sequential process. This approach is very time consuming and cannot be easily extended or modified to correctly configure new components and/or new computing devices.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards providing a properly configured operating system environment by accounting for relationships among different operating system components when scheduling computing tasks. In one aspect, a scheduler component running within a computing device is configured to partition the computing tasks into sets of computing tasks to be executed iteratively. Each set of computing tasks comprises at least one computing task without any dependency (e.g., independent) and/or at least one dependent computing task corresponding to a previously completed task. In one aspect, computing tasks associated with a same set may be executed substantially in parallel.

In one aspect, some computing tasks are configured to correctly install and/or setup operating system components. These tasks may be referred to as self-healing tasks and executed at the initial out-of-box experience stage of the user experience or during system startup and/or recovery. In another aspect, some computing tasks may be executed to provide a computing interface to the properly configured operating system environment. In yet another aspect, some computing tasks may be executed after a system event, such as a login event or a logout event of a user account.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram illustrating an example computing device for scheduling computing tasks based upon dependencies in accordance with at least one example implementation.

FIG. 2 is a block diagram illustrating an example system for scheduling self-healing task execution based upon inter-task dependencies in accordance with at least one example implementation.

FIG. 3 is a representation illustrating dynamic dependency evaluation during self-healing task execution in accordance with at least one example implementation.

FIG. 4 is a flow diagram illustrating example steps for executing self-healing tasks to configure a computing device in accordance with at least one example implementation.

FIG. 5 is a block diagram representing example non-limiting networked environments in which various embodiments described herein can be implemented.

FIG. 6 is a block diagram representing an example non-limiting computing system or operating environment in which one or more aspects of various embodiments described herein can be implemented.

### DETAILED DESCRIPTION

Various aspects of the technology described herein are generally directed towards a scheduler component configured to control computing task execution by evaluating dependencies with respect to each iteration of task execution. The scheduler component starts an initial iteration by executing computing tasks that are not dependent on any other task that is scheduled to be executed in a same iteration or a different iteration.

After each task is completed, the scheduler component records the task as completed and evaluates each remaining task that has not yet executed to determine if that task is independent or dependent on another task that has completed successfully. The scheduler component continues in this manner until all the computing tasks have completed successfully or one or more tasks have failed. According to one example implementation of the scheduler component, only tasks without current dependencies, such as independent tasks and/or tasks that depend upon successfully executed tasks, are selected for execution in parallel. Another example implementation of the scheduler component may skip each failed task and/or any task which depends on a failed task which either failed or were not executed will not have been executed.

As mentioned herein, the computing tasks may include self-healing tasks of which some may correspond to a particular user experience stage/mode. One example stage/mode covers an out-of-box experience (OOBE) when the user begins operating a newly configured computing device for a first time. Self-healing tasks performed during the OOBE may include resetting user accounts (e.g., Microsoft® Windows® MultiPoint™ Server user accounts), creating/fixing a special user account/shell application (e.g., Microsoft® Windows® MultiPoint™ Server shell application “WmsShell”), setting auto-logon options, configuring user related machine settings (e.g., quality management, error reporting and/or the like).

An operating system startup mode refers to booting up operating system components and performing service startup tasks, such as creating/fixing firewall rules, cleaning up dump files, creating/fixing Remote Desktop Services (RDS) listener components, and/or the like. Other example service startup tasks may include, but are not limited to, creating/fixing main special user accounts (e.g., WmsShell), setting/fixing auto-logon options, setting user policies, updating hibernate files and updating storage protection.

After building the operating system environment, certain self-healing tasks may be performed while preparing the operating system environment for deployment to a client computing device. Such self-healing tasks may include creating/fixing particular firewall rules, creating a Microsoft® Windows® MultiPoint™ Server connector share, creating a user control account, creating/fixing RDS listener components, pre-configuring a special user account/administrator account, enabling PowerShell remoting, enabling tracing, installing Microsoft® Windows® MultiPoint™ Server drivers, configuring OOBE settings, setting power policies and configuring particular operating system (OS) services, such as terminal window services.

It should be understood that any of the examples herein are non-limiting. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computing and computing task management in general.

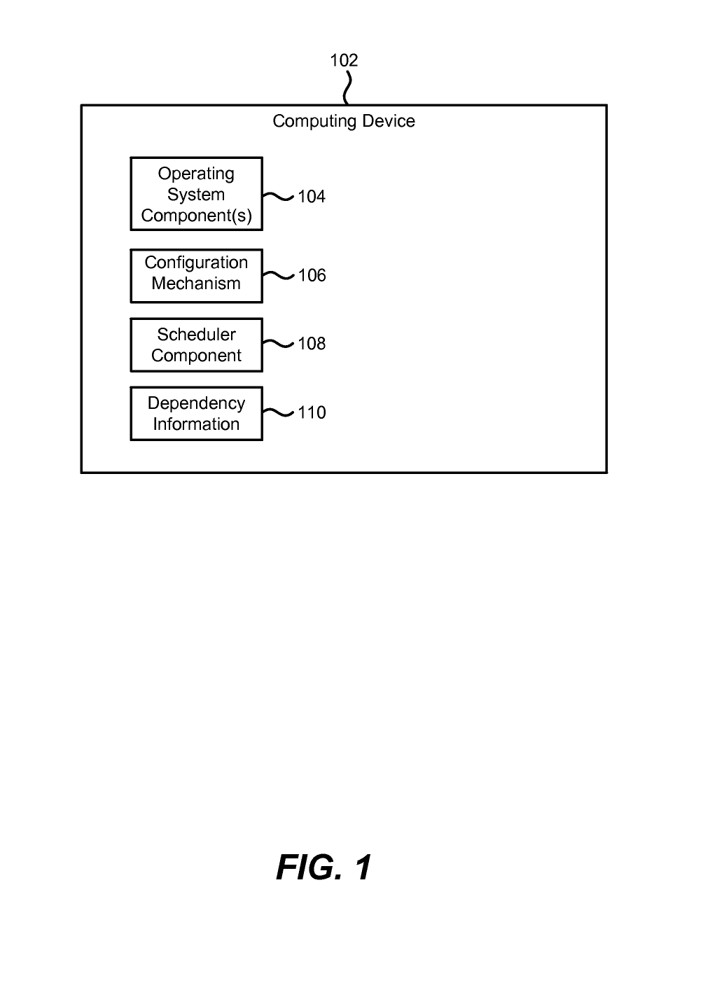

FIG. 1 is a block diagram illustrating an example computing device for computing task scheduling based upon dependencies in accordance with at least one example implementation. FIG. 1 depicts the example computing device as a computing device 102 comprising various hardware and/or software components, such as operating system components 104.

Another component of the computing device 102, depicted in FIG. 1 as a configuration mechanism 106, may execute various computing tasks. Some of these tasks include self-healing tasks designed to configure one or more hardware and/or software components, such as the operating system components 104, correctly and/or efficiently. Such configuration may occur during an initial computing device setup stage (e.g., out-of-box experience (OOBE)), a startup stage, an operating system deployment stage and/or another stage. Each stage may or may not coincide with one or more system events. For instance, a user login event may prompt the startup stage while, conversely, a user logout event does not correspond to a specific stage.

A scheduler component 108 represents at least one embodiment of hardware and/or software configured to control computing task execution based upon inter-task dependencies. Dependency information 110 may record dependencies between two or more dependent tasks. The scheduler component 108 automatically determines whether one computing task is related to another computing task by examining interactions between these tasks or, alternatively, processes pre-determined settings indicating such a dependency.

According to one example implementation, the dependency information 110 identifies a first task upon which one or more other tasks depend. The scheduler component 108 instructs the configuration mechanism 106 to execute the first task before the one or more other tasks. The scheduler component 108 may use a dependency queue to manifest such instructions in which the first task is inserted into the dependency queue followed by the one or more other tasks. By way of example, if one operating system component depends upon the correct configuration of another operating system component, then any computing task related to the operating system component must wait for the computing tasks related to the other operating system component to complete successfully.

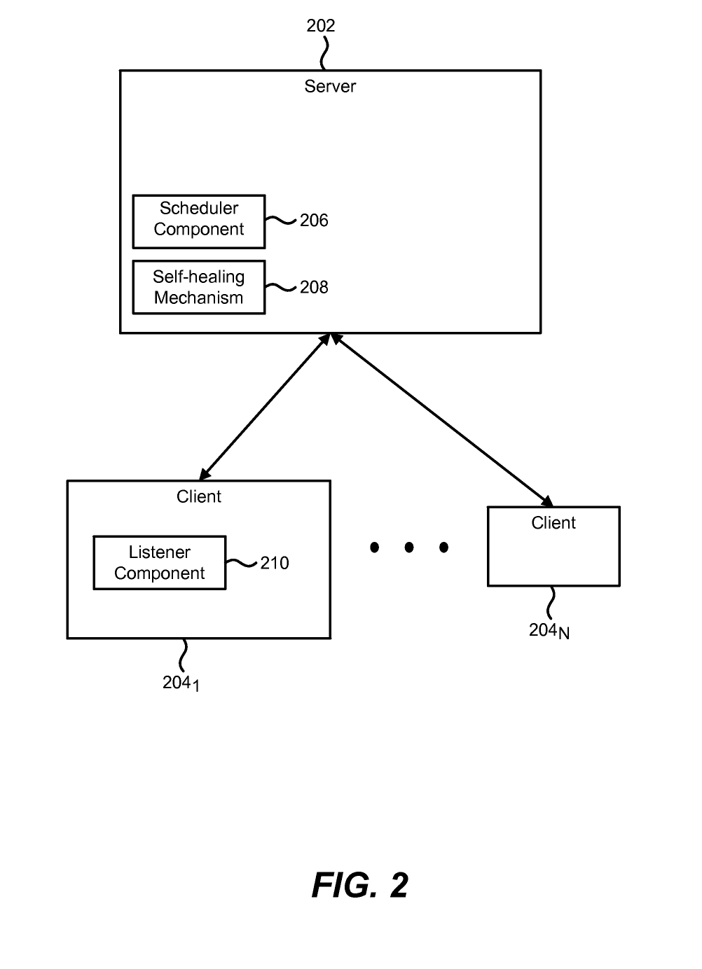

FIG. 2 is a block diagram illustrating an example system for scheduling self-healing task execution based upon inter-task dependencies in accordance with at least one example implementation. Components of the example system may include a server 202 (e.g., the computing device 102 of FIG. 1) configured to provide a plurality of client devices 204 with computing services/resources. Some of these components may generate and host operating system environments for the plurality of client devices 204. The plurality of client devices 204 are depicted in FIG. 2 as a client device 204_{1 . . . N} and are hereinafter referred to as the client devices 204.

A scheduler component 206, residing within the server 202, manages computing task execution performed by a self-healing mechanism 208 or another mechanism. According to at least one example implementation, the self-healing mechanism 208 processes an operating system component and determines whether such component needs some form of improvement or correction. For instance, the operating system component's functionality may need reconfiguration because of effective performance caused by a sub-optimal default initial setup. If the operating system component needs self-healing, the scheduler component 206 inserts one or more associated computing tasks into a dependency queue; otherwise, the self-healing mechanism 208 processes another operating system component. The scheduler component 206 organizes the dependency queue according to task interdependencies such that computing tasks without any current dependencies are executed before other computing tasks.

Each of the client devices 204 includes hardware and/or software components that operate with each other to provide a user with a desktop. The client device 204₁, which represents one example client device in accordance with one or more example implementations, includes a listener component 210 having functionality interacts with the scheduler component 108 of the server 202. A Remote Desktop Protocol (RDP) listener represents one example embodiment of the listener component 210.

The server 202 provides a properly configured operating system environment to one of the clients 204 by using the self-healing mechanism 208 to perform certain computing tasks, for example, to establish computer names and/or automatic upgrade settings during an initial setup stage. Incorrect/ineffective default settings may necessitate such computing tasks, but other reasons for self-healing may exist. As an example, the self-healing mechanism installs computer programs (e.g., a customer experience monitoring/improvement program) or changes settings according to user instructions. There are other computing tasks associated with self-healing and it is appreciated that the present disclosure envisions other computing tasks besides those tasks described herein.

During the initial setup stage, the self-healing mechanism 208 executes a first task configuring each listener component 210 to listen on one or more communication ports for data (e.g., authentication requests). After establishing a host name and an address resolving to these ports, the self-healing mechanism 208 performs a second task for generating a user account, including a special administrator account and/or an auto-logon user account. Because the second task depends upon the first task, the scheduler component 206 waits to execute the second task until the first task completed successfully or substantially. The scheduler component 206 may schedule a third task to run concurrently with the second task provided that no interdependency exists between the second task and the third task and/or that the third task does not depend on another task that has not yet completed successfully.

One example third task generates and/or corrects configuration information, pertaining to the clients 204. The self-healing mechanism 208 stores data comprising mappings between hardware and/or software components, which define at least the operating system environment for the client 204₁. If a set of peripheral devices (e.g., a keyboard) and a display device are co-located and coupled to each other, the self-healing mechanism 208 records a suitable mapping identifying these devices. The self-healing mechanism 208 configures the listener component 210 for the client 204₁ to use the mapping when presenting a computing interface via the display device and processing input/output data for the peripheral devices.

Once the self-healing mechanism 208 verifies the configuration of the client 204₁, the scheduler component 206 selects yet another fourth task, which includes configuring and running a software program (e.g., a shell application, which may be known as “WmShell”), in addition to any related settings. When launched, the software program creates a user account and manages that account at the client 204₁, for example. The software program may produce an interface to the operating system environment for display at one monitor. The interface may be referred to as a terminal services window.

The self-healing mechanism 202 uses the special user account to identify and access the software program's functionality. The self-healing mechanism 208 may instruct the software program to provide the listener component 210 with a host name of the server 202, via wireless or wired communication, such that the listener component 210 only accepts data from the server 202. The listener component 210 also may accept requests having a particular address (e.g., an Internet Protocol (IP) address) matching the address for one of the ports.

The server 202 represents embodiments in which an operating system environment is built and projected onto one or more of the clients 204. One example includes providing a Microsoft® Windows® Server® operating system as part of a computing interface, which may be referred to as a remote desktop, terminal window or session. Using Remote Desktop Services (RDS) technology, for example, the server 202 may provide the computing interface and may be further configured to host multiple simultaneous independent computing terminals/monitors connected to the server 202. Alternatively, the self-healing mechanism 208 recognizes the user account is not configured to auto-logon and changes an auto-logon setting such that the user account automatically logs into the server 202. The auto-logon setting enables the self-healing mechanism 208 to proceed to a next task.

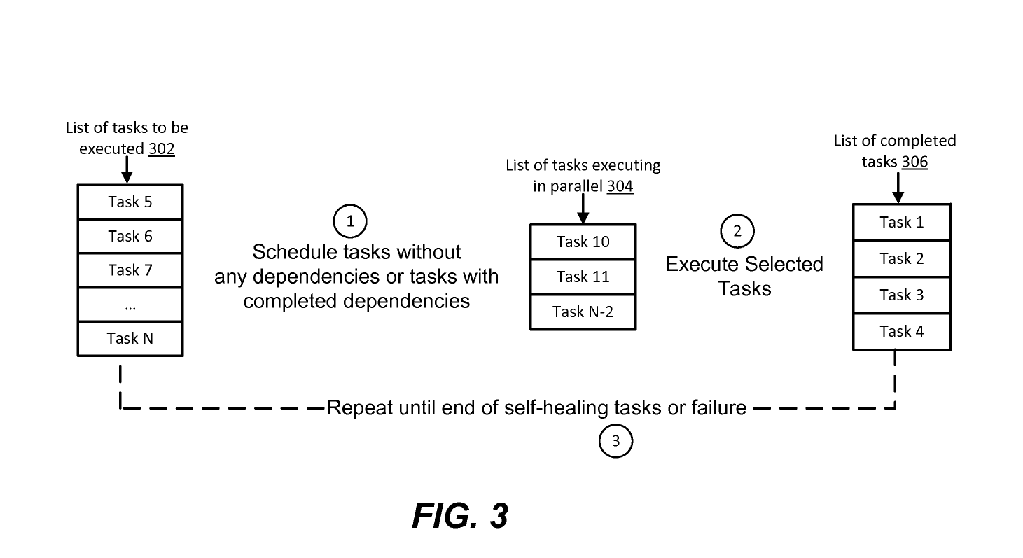

FIG. 3 is a representation illustrating dynamic dependency evaluation during self-healing task execution in accordance with at least one example implementation. As described herein, a scheduler component may examine dependencies between executions of self-healing tasks 302 on a computing device. FIG. 3 expresses the self-healing tasks 302 as a set in which each task number identifies a specific task to be executed. Initially, the self-healing tasks 302 may be labeled from “Task 1” to “Task N” where “Task N” refers to an Nth self-healing task.

Operation (1) selects a portion of the self-healing tasks 302 for execution, such as tasks without any dependencies, tasks with completed dependencies, and/or other tasks satisfying alternative conditions. FIG. 3 represents the selected portion as a schedule 304 listing one or more currently executing self-healing tasks. Some of the tasks in the schedule 304 may be executed in parallel. Operation (2) finalizes self-healing task execution by which one or more tasks are added to a set of completed tasks 306. Operation (3) repeats Operation (1) and Operation (2) until reaching an end of the self-healing tasks 302, unless a task failure occurs.

Consider the following scheduling example in which self-healing tasks labeled “Task 1”, “Task 2”, “Task 3” and “Task 4” successfully executed after one or more iterations of Operations (1), (2) and (3). Information related to the completed tasks 306 is updated to include “Task 1”, “Task 2”, “Task 3” and “Task 4” labels and accordingly, the schedule 304 is marked as completed and later, purged of data identifying these tasks.

Because the self-healing tasks “Task 1”, “Task 2”, “Task 3” and “Task 4” completed without a failure in this example, the scheduler component repeats Operation (1). After reevaluating dependencies between remaining ones of the self-healing tasks 302, the scheduler component selects another set of self-healing tasks to be executed in parallel during Operation (2). For instance, the scheduler component may select “Task 10”, “Task 11” and “Task N−2” as illustrated in FIG. 3. Similar to the previous iteration, Operation (3) determines whether any of these self-healing tasks caused or returned an error or otherwise failed. If all the scheduled self-healing tasks executed completely and/or successfully, Operation (3) proceeds to perform Operation (1) and Operation (2), except for when the set of the self-healing tasks 302 is empty.

One alternative implementation of Operation (3) performs various failure management processes in response to a task failure, including rolling back each failed task. For instance, Operation (3) may reinsert a failed task back into the set of the self-healing tasks 302, which schedules the failed task for execution at a later iteration. Operation (3) also may perform various self-healing tasks to correct the task failure.

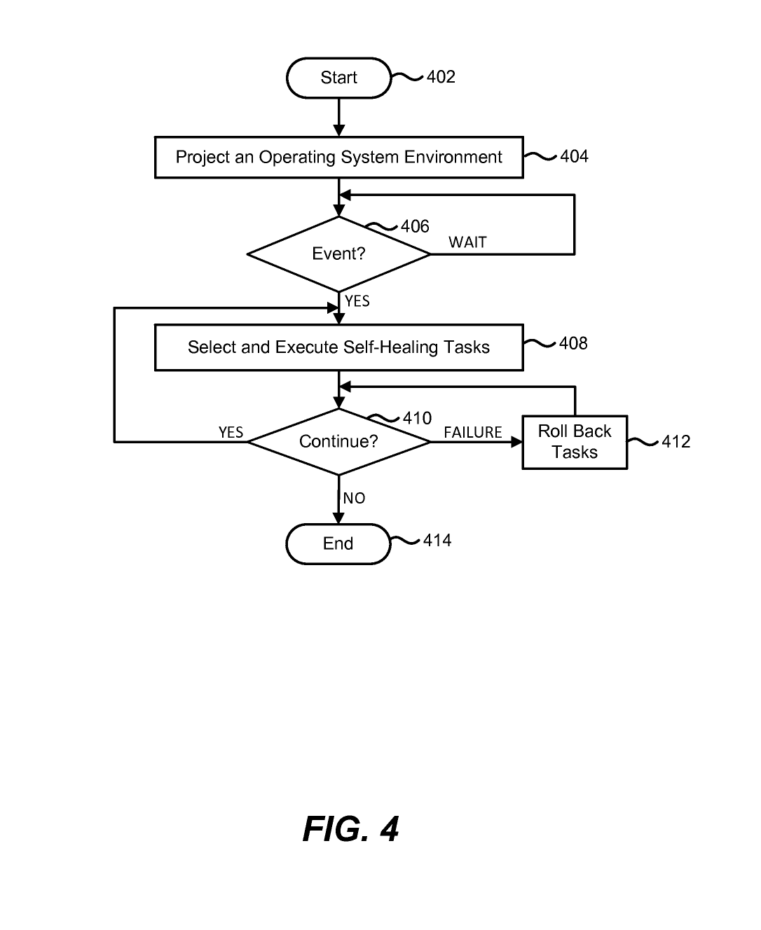

FIG. 4 is a flow diagram illustrating example steps for executing self-healing tasks to configure a computing device in accordance with at least one example implementation. The example steps commence at step 402 and proceed to step 404 at which an operating system environment is projected onto the computing device at a startup stage. A scheduler component, running within the computing device or a server coupled to the computing device, configures the computing device to present a computing interface to the operating system environment. Accordingly, the computing device may be referred to as a remote terminal/desktop.

Step 406 identifies an event that occurred in the operating system environment. Example events include user account login/logout events, user account setup, new component installation/removal, a new computing device, a startup configuration and/or the like. When a computing device joins a domain, the server performs self-healing tasks and halts other computing tasks while the self-healing tasks are executing. As an example, the server configures the joined computing device's user account to auto-login. If a self-healing mechanism recognizes the user account is not configured to auto-logon, the self-healing mechanism changes an auto-logon setting such that the user account automatically logs into the server. The auto-logon setting enables the self-healing mechanism to proceed to a next task.

Step 408 selects self-healing tasks and executes these tasks until completion or failure. As described herein, the scheduler component is configured to select non-dependent self-healing tasks and/or interdependent self-healing tasks. The non-dependent self-healing tasks may be independent and/or currently without any dependencies. Step 408 also updates a schedule to indicate which tasks completed successfully. Alternatively, step 408 modifies each completed self-healing task by, for example, modifying one or more flags signifying completion. Step 410 determines whether to continue executing additional self-healing tasks. If step 410 recognizes a task failure based upon task results, step 410 proceeds to step 412. Step 412 is directed to rolling back tasks by undoing changes until an acceptable state. Step 412 returns to step 410 where it is determined whether or not to continue executing other self-healing tasks.

If step 410 decides that an iteration of self-healing task execution completed successfully and more self-healing tasks are to be selected, step 410 returns to step 406. If step 410 decides that the iteration of self-healing task execution completed successfully but no more self-healing tasks are available, step 410 proceeds to step 414 where the example steps terminate. If the system event is a login event for the user account, step 414 generates a computing interface corresponding to the operating system environment for presentation to the user. The user may accordingly use the computing interface to access resources/services provided by the operating system environment. If the system event is a logout event for the user account, step 414 destructs the computing interface to the operating system environment. The user may safely log off because operating system components are no longer configured to communicate with the computing device.

### Example Networked and Distributed Environments

One of ordinary skill in the art can appreciate that the various embodiments and methods described herein can be implemented in connection with any computer or other client or server device, which can be deployed as part of a computer network or in a distributed computing environment, and can be connected to any kind of data store or stores. In this regard, the various embodiments described herein can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

Distributed computing provides sharing of computer resources and services by communicative exchange among computing devices and systems. These resources and services include the exchange of information, cache storage and disk storage for objects, such as files. These resources and services also include the sharing of processing power across multiple processing units for load balancing, expansion of resources, specialization of processing, and the like. Distributed computing takes advantage of network connectivity, allowing clients to leverage their collective power to benefit the entire enterprise. In this regard, a variety of devices may have applications, objects or resources that may participate in the resource management mechanisms as described for various embodiments of the subject disclosure.

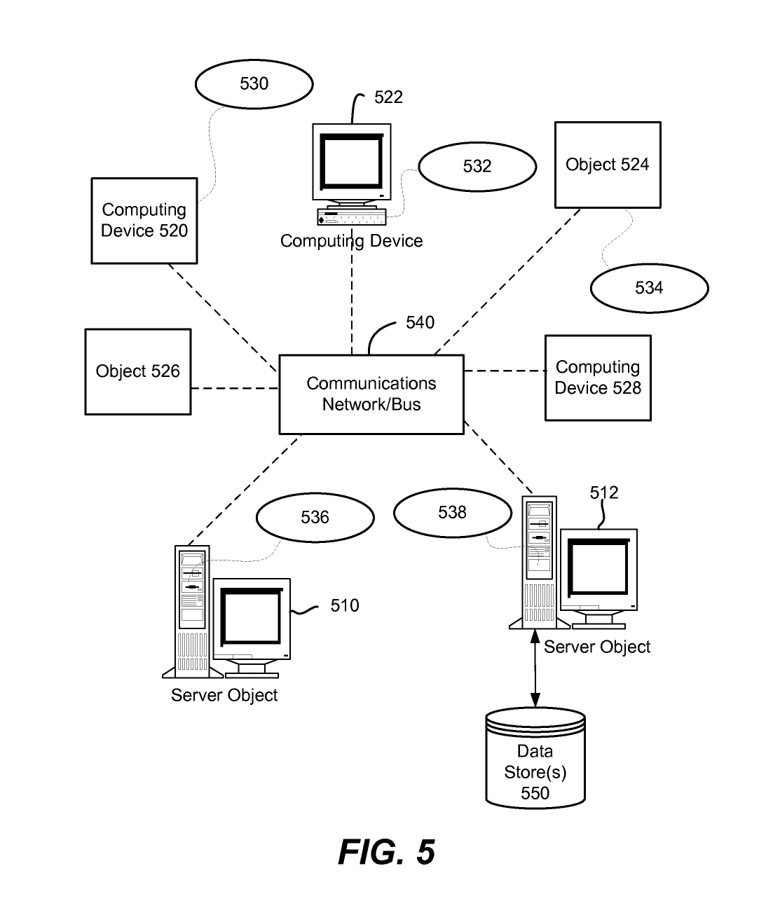

FIG. 5 provides a schematic diagram of an example networked or distributed computing environment. The distributed computing environment comprises computing objects 510, 512, etc., and computing objects or devices 520, 522, 524, 526, 528, etc., which may include programs, methods, data stores, programmable logic, etc. as represented by example applications 530, 532, 534, 536, 538. It can be appreciated that computing objects 510, 512, etc. and computing objects or devices 520, 522, 524, 526, 528, etc. may comprise different devices, such as personal digital assistants (PDAs), audio/video devices, mobile phones, MP3 players, personal computers, laptops, etc.

Each computing object 510, 512, etc. and computing objects or devices 520, 522, 524, 526, 528, etc. can communicate with one or more other computing objects 510, 512, etc. and computing objects or devices 520, 522, 524, 526, 528, etc. by way of the communications network 540, either directly or indirectly. Even though illustrated as a single element in FIG. 5, communications network 540 may comprise other computing objects and computing devices that provide services to the system of FIG. 5, and/or may represent multiple interconnected networks, which are not shown. Each computing object 510, 512, etc. or computing object or device 520, 522, 524, 526, 528, etc. can also contain an application, such as applications 530, 532, 534, 536, 538, that might make use of an API, or other object, software, firmware and/or hardware, suitable for communication with or implementation of the application provided in accordance with various embodiments of the subject disclosure.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for example communications made incident to the systems as described in various embodiments.

Thus, a host of network topologies and network infrastructures, such as client/server, peer-to-peer, or hybrid architectures, can be utilized. The “client” is a member of a class or group that uses the services of another class or group to which it is not related. A client can be a process, e.g., roughly a set of instructions or tasks, that requests a service provided by another program or process. The client process utilizes the requested service without having to “know” any working details about the other program or the service itself.

In a client/server architecture, particularly a networked system, a client is usually a computer that accesses shared network resources provided by another computer, e.g., a server. In the illustration of FIG. 5, as a non-limiting example, computing objects or devices 520, 522, 524, 526, 528, etc. can be thought of as clients and computing objects 510, 512, etc. can be thought of as servers where computing objects 510, 512, etc., acting as servers provide data services, such as receiving data from client computing objects or devices 520, 522, 524, 526, 528, etc., storing of data, processing of data, transmitting data to client computing objects or devices 520, 522, 524, 526, 528, etc., although any computer can be considered a client, a server, or both, depending on the circumstances.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server.

In a network environment in which the communications network 540 or bus is the Internet, for example, the computing objects 510, 512, etc. can be Web servers with which other computing objects or devices 520, 522, 524, 526, 528, etc. communicate via any of a number of known protocols, such as the hypertext transfer protocol (HTTP). Computing objects 510, 512, etc. acting as servers may also serve as clients, e.g., computing objects or devices 520, 522, 524, 526, 528, etc., as may be characteristic of a distributed computing environment.

### Example Computing Device

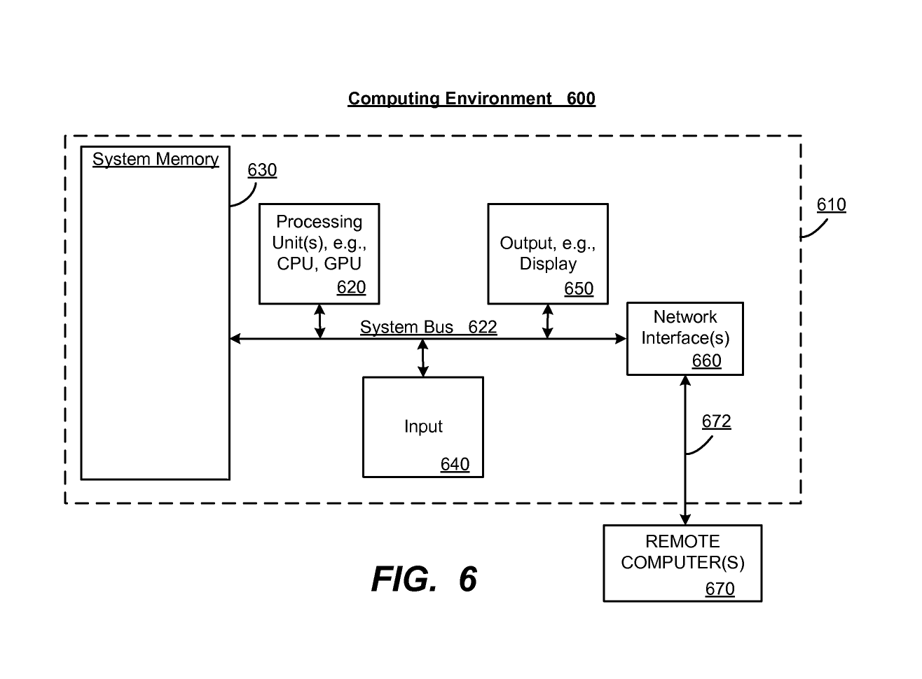

As mentioned, advantageously, the techniques described herein can be applied to any device. It can be understood, therefore, that handheld, portable and other computing devices and computing objects of all kinds are contemplated for use in connection with the various embodiments. Accordingly, the below general purpose remote computer described below in FIG. 6 is but one example of a computing device.

Embodiments can partly be implemented via an operating system, for use by a developer of services for a device or object, and/or included within application software that operates to perform one or more functional aspects of the various embodiments described herein. Software may be described in the general context of computer executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol is considered limiting.

FIG. 6 thus illustrates an example of a suitable computing system environment 600 in which one or aspects of the embodiments described herein can be implemented, although as made clear above, the computing system environment 600 is only one example of a suitable computing environment and is not intended to suggest any limitation as to scope of use or functionality. In addition, the computing system environment 600 is not intended to be interpreted as having any dependency relating to any one or combination of components illustrated in the example computing system environment 600.

With reference to FIG. 6, an example remote device for implementing one or more embodiments includes a general purpose computing device in the form of a computer 610. Components of computer 610 may include, but are not limited to, a processing unit 620, a system memory 630, and a system bus 622 that couples various system components including the system memory to the processing unit 620.

Computer 610 typically includes a variety of computer readable media and can be any available media that can be accessed by computer 610. The system memory 630 may include computer storage media in the form of volatile and/or nonvolatile memory such as read only memory (ROM) and/or random access memory (RAM). By way of example, and not limitation, system memory 630 may also include an operating system, application programs, other program modules, and program data.

A user can enter commands and information into the computer 610 through input devices 640. A monitor or other type of display device is also connected to the system bus 622 via an interface, such as output interface 650. In addition to a monitor, computers can also include other peripheral output devices such as speakers and a printer, which may be connected through output interface 650.

The computer 610 may operate in a networked or distributed environment using logical connections to one or more other remote computers, such as remote computer 670. The remote computer 670 may be a personal computer, a server, a router, a network PC, a peer device or other common network node, or any other remote media consumption or transmission device, and may include any or all of the elements described above relative to the computer 610. The logical connections depicted in FIG. 6 include a network 672, such local area network (LAN) or a wide area network (WAN), but may also include other networks/buses. Such networking environments are commonplace in homes, offices, enterprise-wide computer networks, intranets and the Internet.

As mentioned above, while example embodiments have been described in connection with various computing devices and network architectures, the underlying concepts may be applied to any network system and any computing device or system in which it is desirable to improve efficiency of resource usage.

Also, there are multiple ways to implement the same or similar functionality, e.g., an appropriate API, tool kit, driver code, operating system, control, standalone or downloadable software object, etc. which enables applications and services to take advantage of the techniques provided herein. Thus, embodiments herein are contemplated from the standpoint of an API (or other software object), as well as from a software or hardware object that implements one or more embodiments as described herein. Thus, various embodiments described herein can have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used, for the avoidance of doubt, such terms are intended to be inclusive in a manner similar to the term “comprising” as an open transition word without precluding any additional or other elements when employed in a claim.

As mentioned, the various techniques described herein may be implemented in connection with hardware or software or, where appropriate, with a combination of both. As used herein, the terms “component,” “module,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it can be noted that one or more components may be combined into a single component providing aggregate functionality or divided into several separate sub-components, and that any one or more middle layers, such as a management layer, may be provided to communicatively couple to such sub-components in order to provide integrated functionality. Any components described herein may also interact with one or more other components not specifically described herein but generally known by those of skill in the art.

In view of the example systems described herein, methodologies that may be implemented in accordance with the described subject matter can also be appreciated with reference to the flowcharts of the various figures. While for purposes of simplicity of explanation, the methodologies are shown and described as a series of blocks, it is to be understood and appreciated that the various embodiments are not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, some illustrated blocks are optional in implementing the methodologies described hereinafter.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

In addition to the various embodiments described herein, it is to be understood that other similar embodiments can be used or modifications and additions can be made to the described embodiment(s) for performing the same or equivalent function of the corresponding embodiment(s) without deviating therefrom. Still further, multiple processing chips or multiple devices can share the performance of one or more functions described herein, and similarly, storage can be effected across a plurality of devices. Accordingly, the invention is not to be limited to any single embodiment, but rather is to be construed in breadth, spirit and scope in accordance with the appended claims.

What is claimed is:

1. In a computing environment, a method performed at least in part on at least one processor, comprising, scheduling execution of a plurality of computing tasks based upon dependency information, including, (a) executing a portion of the plurality of computing tasks in parallel, (b) executing at least one dependent computing task, (c) examining a remaining portion of the plurality of computing tasks using the dependency information, and (d) repeating at least one of (a) or (b) or (c) until completion of the plurality of computing tasks.

2. The method of claim 1 wherein (a) executing the portion of the plurality of computing tasks in parallel further comprises selecting the portion of the computing tasks to execute in parallel.

3. The method of claim 1 wherein (a) executing the portion of the plurality of computing tasks in parallel further comprises executing a computing task without any dependency.

4. The method of claim 1 wherein (a) executing the portion of the plurality of computing tasks in parallel further comprises executing a computing task that depends upon completed computing tasks.

5. The method of claim 1 further comprising managing a task failure and repeating (d).

6. The method of claim 1 further comprising rolling back one or more failed computing tasks.

7. The method of claim 1 further comprising scheduling execution of the plurality of computing tasks in response to a system event.

8. The method of claim 1 further comprising scheduling execution of the plurality of computing tasks for an initial configuration of a computing device.

9. The method of claim 1 further comprising scheduling execution of the plurality of computing tasks to configure an operating system component.

10. The method of claim 1 further comprising scheduling execution of the plurality of computing tasks in association with operating system startup.

11. In a computing environment, a system comprising, a scheduler component for a computing device, wherein the scheduler component is configured to examine interdependencies corresponding to a plurality of self-healing tasks for the computing device, select one or more self-healing tasks of the plurality of self-healing tasks based upon the interdependencies, and if the one or more self-healing tasks execute to completion, select one or more other self-healing tasks for execution.

12. The system of claim 11, wherein the scheduler component is further configured to select at least one of an independent self-healing task or an interdependent self-healing task for execution.

13. The system of claim 11, wherein the scheduler component is further configured to identify a new computing device having a user account and set an auto-logon setting for the user account.

14. The system of claim 11, wherein the scheduler component is further configured to select self-healing tasks without any current dependency, and wherein the self-healing tasks are executed in parallel and wait for the self-healing tasks to complete.

15. The system of claim 11 further comprising a self-healing mechanism configured to communicate with the scheduler component and execute the one or more self-healing tasks of the plurality of self-healing tasks.

16. The system of claim 11, wherein the scheduler component is further configured to identify a login event or a logout event corresponding to a user account and selecting the plurality of self-healing tasks based on the login event or the logout event.

17. One or more computer-readable media having computer-executable instructions, which when executed perform steps, comprising:
projecting an operating system environment onto a computing device;
processing the operating system environment in response to a system event; and
for each iteration of self-healing task execution, selecting a set of self-healing tasks in which each task is not dependent on another task, and waiting for the set of self-healing tasks to complete or fail.

18. The one or more computer-readable media of claim 17 further comprising:
identifying an operating system component for self-healing; and
scheduling one or more corresponding computing tasks to configure the operating system component.

19. The one or more computer-readable media of claim 17 further comprising:
rolling back each failed task of the set of self-healing tasks and scheduling one or more self-healing tasks for execution.

20. The one or more computer-readable media of claim 17 having further computer-executable instructions comprising:
if the system event is a login event, configuring the computing device to present a computing interface corresponding to the operating system environment; or
If the system event is a logout event, configuring the computing device to destruct the computing interface corresponding to the operating system environment.
